(19) United States
(12) Patent Application Publication
(10) Pub. No.: US 2024/0119211 A1
(43) Pub. Date: Apr. 11, 2024

(54) SEMICONDUCTOR DESIGN OPTIMIZATION SYSTEMS AND METHODS OF OPERATION THEREOF

(71) Applicant: Samsung Electronics Co., Ltd., Suwon-si (KR)

(72) Inventors: Eun-Ho Lee, Suwon-si (KR); Jae Choon Kim, Suwon-si (KR); Tae-Hyun Kim, Suwon-si (KR); Jeong-Hyeon Park, Suwon-si (KR); Hwanjoo Park, Suwon-si (KR); Sunggu Kang, Suwon-si (KR); Sung-Ho Mun, Suwon-si (KR)

(73) Assignees: Samsung Electronics Co., Ltd., Suwon-si (KR); Research & Business Foundation SUNGKYUNKWAN UNIVERSITY, Suwon-si (KR)

(21) Appl. No.: 18/206,278

(22) Filed: Jun. 6, 2023

(30) Foreign Application Priority Data
Oct. 11, 2022 (KR) 10-2022-0129656

(51) Int. Cl. G06F 30/392; G06N 20/00

(52) U.S. Cl. CPC G06F 30/392; G06N 20/00

(57) ABSTRACT

A semiconductor design optimization system that includes: a data base configured to store design data, a training data preprocessing unit configured to preprocess the design data and generate training data, a data learning unit configured to generate a physical property prediction model by training using the training data, a physical property prediction unit configured to generate predicted physical property data including information associated with predicted physical property values for each region of a semiconductor device to be fabricated, wherein the physical property prediction unit is configured to input, into the physical property prediction model, input data including information associated with design drawings of the semiconductor device to be fabricated, and a layout generator configured generate a design layout optimized to distribute the predicted physical property values for each region of the semiconductor device to be fabricated by modifying the design drawings based on the predicted physical property data.

### CROSS-REFERENCE TO RELATED APPLICATION

This application claims priority under 35 U.S.C. § 119 to Korean Patent Application No. 10-2022-0129656, filed on Oct. 11, 2022, in the Korean Intellectual Property Office, and the entire contents of the above-identified application are incorporated by reference herein.

### BACKGROUND

Aspects of the present disclosure relate to semiconductor design optimization systems and operation methods thereof. More particularly, aspects of the present disclosure relate to systems that predict physical properties of semiconductor devices using physical property prediction models obtained from training semiconductor design drawings and generate optimized design layouts, and operation methods of such systems.

As semiconductor devices become highly integrated and miniaturized, various unintended thermal and electrical characteristics may occur in the semiconductor devices due to complex effects and/or interactions of factors at each stage of designing and fabricating the semiconductor devices. Accordingly, to overcome the limitations of semiconductor processes and devices, to understand phenomena, and to reduce experiment costs, demand within the semiconductor industry for process-device simulation environments is further increasing. In addition, to provide accurate product specifications of semiconductor devices, it is increasingly desirable and in some instances may be a requirement to predict and simulate characteristics of semiconductor devices with a degree of accuracy.

### SUMMARY

Aspects of the present disclosure provide systems for predicting physical properties of semiconductor devices using image data of design drawings.

Aspects of the present disclosure provide systems for predicting physical properties of a semiconductor device and generating a design layout with optimized physical properties.

According to some embodiments of the present disclosure, a semiconductor design optimization system may include: a data base configured to store design data, a training data preprocessing unit configured to obtain the design data from the data base and preprocess the design data to generate training data, a data learning unit configured to generate a physical property prediction model by training using the training data, a physical property prediction unit configured to generate predicted physical property data including information associated with predicted physical property values for each region of a semiconductor device to be fabricated, wherein the physical property prediction unit is configured to input, into the physical property prediction model, input data including information associated with design drawings of the semiconductor device and a layout generator configured to generate a design layout for the semiconductor device to be fabricated, wherein the design layout is optimized to distribute the predicted physical property values for each region of the semiconductor device by modifying the design drawings based on the predicted physical property data.

According to some embodiments of the present disclosure, a semiconductor optimization method may include: generating training data by preprocessing design data, generating a physical property prediction model by training using the training data, generating predicted physical property data including information associated with predicted physical property values for each region of a semiconductor device to be fabricated, including inputting into the physical property prediction model input data including information associated with design drawings of the semiconductor device to be fabricated, and generating a design layout optimized to distribute the predicted physical property values for each region of the semiconductor device by modifying the design drawings based on the predicted physical property data.

According to some embodiments of the present disclosure, a semiconductor design optimization system may include: a training data preprocessing unit configured to generate training data including a plurality of unit cells each labeled with an effective physical property value, the training data preprocessing unit configured to preprocess design drawings of a semiconductor device to be fabricated and physical property information associated with materials arranged in the design drawings, a data learning unit configured to generate a physical property prediction model as a result of training using the training data and a physical property prediction unit configured to generate information associated with predicted physical property values for each region of the semiconductor device to be fabricated, the physical property prediction unit configured to input into the physical property prediction model information associated with the design drawings of the semiconductor device to be fabricated. The design drawings may be in a form of image data, and the physical property information may include a thermal conductivity of a metal material and a thermal conductivity of an insulating material.

### BRIEF DESCRIPTION OF THE FIGURES

A detailed description of each drawing is provided to facilitate a more thorough understanding of the drawings referenced in the detailed description of the present disclosure.

FIG. 1 is a diagram illustrating an embodiment of a semiconductor fabricating system, according to some aspects of the present disclosure.

FIG. 2 is a block diagram illustrating an embodiment of a semiconductor design optimization system in a semiconductor fabricating system of FIG. 1 according to some aspects of the present disclosure.

FIG. 3 is a diagram illustrating types of data stored in a data base of FIG. 2.

FIG. 4 is a block diagram illustrating specific configurations of a training data preprocessing unit of FIG. 2.

FIG. 5 is a flowchart for describing an operation of a training data preprocessing unit of FIG. 4.

FIG. 6 is a diagram illustrating an example of converted image data generated in a training data preprocessing unit of FIG. 4.

FIG. 7 is a diagram illustrating an example of divided image data divided by an image divider of FIG. 4.

FIG. 8 is an enlarged view of a first unit cell in divided image data of FIG. 7.

FIGS. 9 and 10 are diagrams for describing that a FEM processing unit of FIG. 4 extracts effective physical property values.

FIG. 11 is a diagram for describing that a physical property labeling unit of FIG. 4 labels effective physical property values.

FIG. 12 is a flowchart for describing an operation of generating predicted physical property data by a physical property prediction unit of FIG. 2.

FIG. 13 is a diagram illustrating an example of a semiconductor device to be designed in a semiconductor fabricating system of FIG. 2.

FIG. 14 is a diagram illustrating design drawings of a semiconductor device of FIG. 13.

FIG. 15 is a block diagram illustrating an embodiment of a semiconductor design optimization system in FIG. 1 according to some aspects of the present disclosure.

FIG. 16 is a block diagram illustrating an input data preprocessing unit of FIG. 15.

### DETAILED DESCRIPTION

Hereinafter, some examples of embodiments of the present disclosure are described in detail and with sufficient clarity to permit those of ordinary skill in the art to implement the present disclosure.

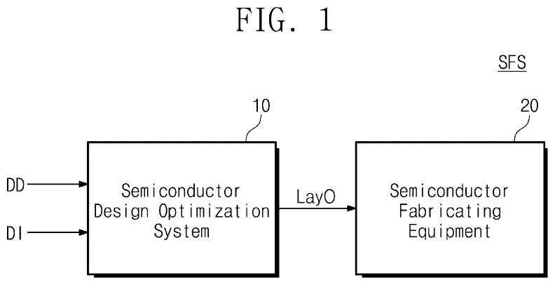

FIG. 1 is a diagram illustrating an embodiment of a semiconductor fabricating system, according to some aspects of the present disclosure. In some embodiments, a semiconductor fabricating system SFS may design and fabricate a semiconductor device based on input data DI and design data DD.

Referring to FIG. 1, the semiconductor fabricating system SFS may include a semiconductor design optimization system 10 and a semiconductor fabricating equipment 20.

The semiconductor design optimization system 10 may generate a design layout LayO of a semiconductor device. In some embodiments, the semiconductor design optimization system 10 may receive the input data DI and the design data DD. The semiconductor design optimization system 10 may predict a physical property of a semiconductor device to be designed based on the input data DI through or using a physical property prediction model trained from the design data DD. The semiconductor design optimization system 10 may generate the design layout LayO in which the physical property is optimized based on the predicted physical property.

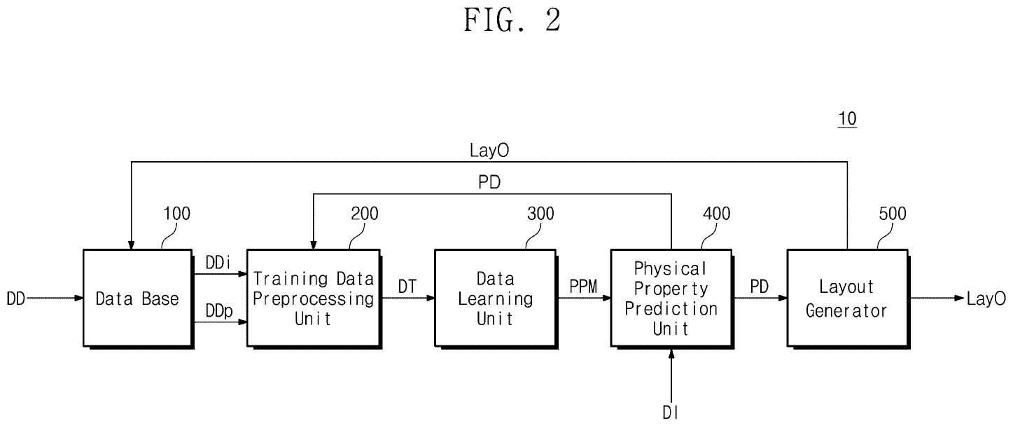

The design data DD may be data for training (e.g., data used to train) a physical property prediction model used in the semiconductor design optimization system 10. The design data DD may include design drawings of various semiconductor devices. The design data DD may include design drawing data DDi and design property data DDp, as seen in FIG. 2 and discussed further herein.

The design drawing data DDi may include design drawings of various semiconductor devices. For example, the various semiconductor devices may include, but are not limited to, PCB substrates, semiconductor substrates, package substrates, semiconductor chips, and/or semiconductor packages.

For example, the design drawing data DDi may include design drawings of layers constituting or a part of a package substrate such as a PCB substrate. As another example, the design drawing data DDi may include design drawings of a semiconductor package including a package substrate and a semiconductor chip.

In the design drawings of the design drawing data DDi, a plurality of wires, a plurality of pads, a plurality of vias, or regions in which chips are to be mounted may be arranged. For example, the design drawing may include drawings in which a pattern including metal wires, metal vias, and metal pads that are arranged (or that are to be arranged) on a nonmetal substrate. A plurality of design drawings may have different types of patterns.

The design property data DDp may include property information associated with materials arranged or present in the design drawing data DDi. For example, the design physical property data DDp may include information associated with thermal and electrical characteristics of metal materials and information associated with thermal and electrical characteristics of nonmetal materials. The metal materials may include a conductive material, such as copper, nickel, titanium, or aluminum, and the nonmetal materials may include an insulating material, such as silicon, silicon nitride, or silicon oxide.

Information associated with the thermal characteristics of the metal materials may include information on thermal conductivity, thermal resistance, and ETC (Effective Thermal Conductivity) of the metal materials, and electrical characteristics of the metal materials may include information associated with the electrical conductivity, power consumption, and electric field of the metal materials. Similarly, information associated with the thermal characteristics of the nonmetal materials may include information on thermal conductivity, thermal resistance, and ETC of the nonmetal materials, and electrical characteristics of the nonmetal materials may include information associated with the electrical conductivity, power consumption, and electric field of the nonmetal materials.

The input data DI may include information associated with design drawings of a semiconductor device to be fabricated. For example, when fabricating a package substrate, design drawings corresponding to each of the layers constituting the package substrate may be provided as the input data DI.

The input data DI may include information associated with patterns of wirings, circuits, etc. arranged on design drawings. For example, the input data may include pattern parameters for adjusting a shape and arrangement of patterns included in each of the design drawings. For example, the pattern parameters may include information for adjusting the sizes of shapes such as vias, pads, wires, and active regions on the design drawings, locations in which the shapes are arranged, and intervals between the shapes.

The design data DD and the input data DI may be provided in the form of image data, but are not limited thereto, and in some embodiments may be provided in the form of a CAD drawing file or a simulation layout file.

In some embodiments, the semiconductor design optimization system 10 may generate the design layout LayO by utilizing a computer-aided design (CAD) tool. The semiconductor design optimization system 10 may be stored in a storage medium in the form of software and may read or executed by a computer. The storage medium may include, but is not limited to, for example, a compact disk, a floppy disk, a random access memory (RAM), and/or a read only memory (ROM).

The semiconductor fabricating equipment 20 may receive the design layout LayO from the semiconductor design optimization system 10. The semiconductor design optimization system 10 may output the design layout LayO and may provide the design layout LayO to the semiconductor fabricating equipment 20.

The semiconductor fabricating equipment 20 may fabricate a semiconductor device using the received design layout LayO. For example, the semiconductor fabricating equipment 20 may fabricate a photomask based on the design layout LayO and may perform a photolithography process using the photomask to fabricate a semiconductor device. Hereinafter, among terms used in this specification, a layout may have the same meaning as a layout graphic.

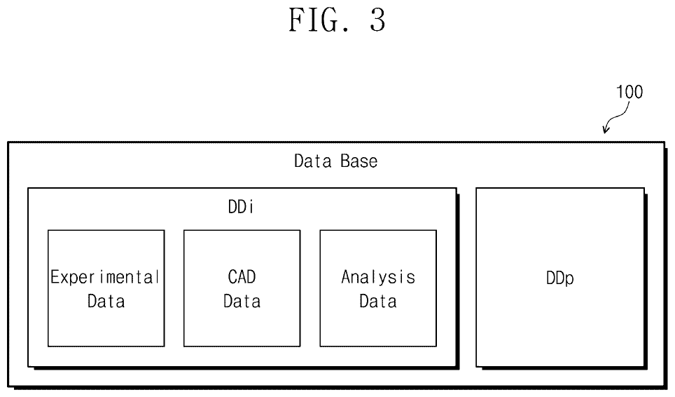

FIG. 2 is a block diagram illustrating an embodiment of a semiconductor design optimization system in a semiconductor fabricating system of FIG. 1 according to some aspects of the present disclosure. FIG. 3 is a diagram illustrating types of data stored in a data base of FIG. 2. Hereinafter, an embodiment of a semiconductor design optimization system 10 according to the present disclosure will be described in detail with reference to FIGS. 2 and 3.

Referring to FIG. 2, the semiconductor design optimization system 10 may include a data base 100 (e.g., database 100), a training data preprocessing unit 200, a data learning unit 300, a physical property prediction unit 400, and a layout generator 500.

Referring to FIG. 3 together with FIG. 2, the data base 100 may receive and store the design data DD. The design data DD stored in the data base 100 may include the design drawing data DDi and the design property data DDp, discussed above. The design drawing data DDi may include experimental data, CAD data, and analysis data.

The experimental data may be data obtained through experiments. For example, the experimental data may include design cross-sectional views of semiconductor devices collected by disassembling various semiconductor devices. For example, the experimental data may be provided in the form of image data in one or more file formats, such as JPG, JPEG, TIF, GIF, PNG, or the like.

The CAD data may be data provided in the form of a file used by a CAD tool. For example, the CAD data may include layout files of a semiconductor device generated by the CAD tool.

The analysis data may be a file in the form of a preprocessed image for artificial intelligence learning. For example, the analysis data may be image data obtained by standardizing an image file of a semiconductor device to meet standards for artificial intelligence learning.

Without being limited to what is illustrated, the design drawing data DDi may include design image data, simulation data, or the like, and may include design image data, simulation data, or the like that is disclosed or available on the Internet.

The design property data DDp may include information associated with physical properties of various metals and nonmetals arranged in the design drawing data DDi. For example, the design property data DDp may include information on thermal and electrical characteristics of metal materials and information on thermal and electrical characteristics of nonmetal materials.

The design drawing data DDi and the design property data DDp stored in the data base 100 may be provided to the training data preprocessing unit 200.

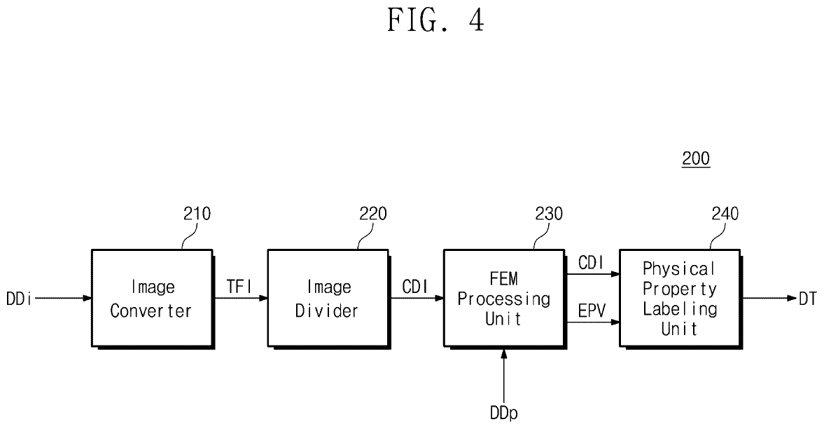

Referring to FIG. 2, the training data preprocessing unit 200 may be configured to receive the design data DD from the data base 100. The training data preprocessing unit 200 may be configured to generate training data DT by preprocessing the design data DD using a finite element method (FEM). The specific configuration and operation of the training data preprocessing unit 200 will be described later with reference to FIGS. 4 to 11.

The training data DT generated by the training data preprocessing unit 200 may include the design drawing data DDi including unit cells to which effective physical property values are labeled. The training data DT generated by the training data preprocessing unit 200 may be provided to the data learning unit 300.

The data learning unit 300 may generate a physical property prediction model PPM by training the training data DT with an artificial intelligence model. The physical property prediction model PPM may be generated by training design drawing data DDi of the training data DT and labeled effective physical property values.

In some embodiments, an effective physical property value with respect to a specific region (or specific unit cell) may be defined as representing an average physical property value with respect to the specific region (or specific unit cell), but the present disclosure is not limited thereto.

The artificial intelligence model may include a supervised learning model. For example, the artificial intelligence models include a K-Nearest Neibors (KNN), a Linear Regression, a Logistic Regression, a Support Vector Machines (SVM), a Decision Trees, a random forest, or a neural network algorithm model such as a convolutional neural network (CNN), a recurrent neural network (RNN), a support vector regression (SVR), etc.

The physical property prediction model PPM generated by the data learning unit 300 may generate predicted physical property data PD by predicting the physical property characteristics of the input design drawing. The physical property prediction model PPM generated by the data learning unit 300 may be provided to the physical property prediction unit 400.

The physical property prediction unit 400 may receive the input data DI. The input data DI may include information associated with patterns of wirings, circuits, etc. arranged on design drawings.

The physical property prediction unit 400 may use the physical property prediction model PPM generated by the data learning unit 300 and then may generate the predicted physical property data PD with respect to the semiconductor device based on the input data DI.

In some embodiments, the physical property prediction unit 400 may generate the predicted physical property data PD including information associated with the predicted physical property values for each region of the designed semiconductor device based on the input data DI. The predicted physical property data PD may include, for example, information associated with predicted heat transfer coefficient (or effective thermal conductivity) for each region of the semiconductor device predicted based on the heat transfer coefficient (or thermal conductivity) of metal and nonmetal patterns on design drawings.

As another example, the predicted physical property data may include information associated with temperature for each region predicted during operation of the semiconductor device based on the design drawing of the input data DI. For example, based on the ratio occupied by the metal pattern and the nonmetal pattern in the semiconductor device that is based on the design drawing of the input data DI, the predicted physical property data PD may be provided such that the region with a high proportion of the metal pattern is indicated at a relatively high temperature, and the region with a high proportion of the nonmetallic pattern is indicated at a relatively low temperature.

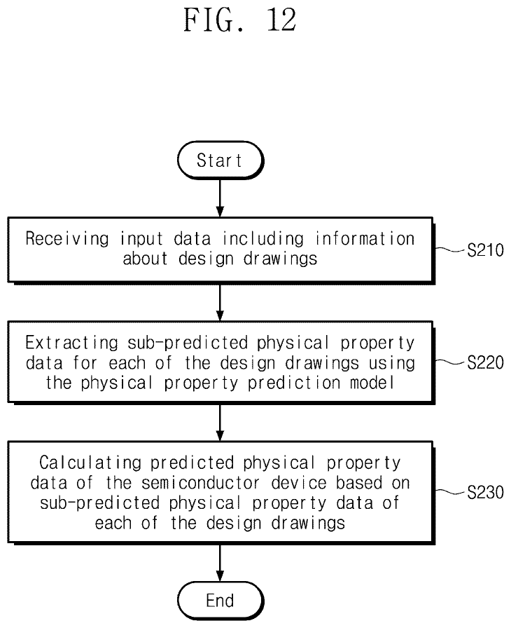

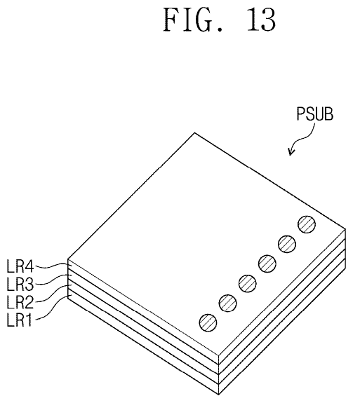

Details of generating the predicted physical property data PD through the physical property prediction unit 400 will be described later with reference to FIGS. 12 to 14.

The predicted physical property data PD generated by the physical property prediction unit 400 may be provided to the data base 100. The data base 100 may store the predicted physical property data PD generated by the physical property prediction unit 400 as the design data DD. Accordingly, the learning model may improve prediction accuracy of the physical property prediction model PPM by training the predicted property data PD generated by the physical property prediction unit 400.

The layout generator 500 may be configured to generate a design layout LayO by optimizing the physical property values based on the predicted physical property data PD. The layout generator 500 may generate a design layout by modifying the design drawings such that predicted physical property values are distributed based on information associated with the predicted physical property values for each region of the semiconductor device in the predicted physical property data PD.

In some embodiments, the layout generator 500 may optimize the design drawings of input data using physical, chemical, electrical, and thermal equilibrium equations based on the predicted physical property data PD such that the predicted physical property values are distributed in the region in which the thermal and electrical properties are concentrated.

In some embodiments, the layout generator 500 may be configured to optimize the shape, location, and arrangement of patterns on design drawings by modifying pattern parameters based on the predicted physical property data PD.

For example, the layout generator 500 may detect a region in which the predicted physical property values are concentrated (e.g., a region in which the predicted thermal conductivity value is greater than or equal to a critical point) in the design drawing based on the predicted physical property data PD, and may modify the pattern parameter such that the interval between the patterns arranged in the concentrated region increases. Thereafter, the layout generator 500 may generate the design layout LayO with respect to the redesigned design drawing based on the modified pattern parameters.

As another example, the layout generator 500 may detect a region indicated with a high temperature at the temperature of each region during operation of the semiconductor device of the predicted physical property data PD, and may modify a thickness of the pattern of the corresponding region and the interval between the patterns to generate the design layout LayO.

However, the present disclosure is not limited thereto, and the layout generator 500 may generate the design layout LayO to improve thermal characteristics and electrical characteristics by redesigning the design drawings according to user input based on the predicted physical property data PD.

The design layout LayO that is generated by the layout generator 500 may be provided to the data base 100. The data base 100 may store the design layout LayO generated by the layout generator 500 as the design data DD. Accordingly, the learning model may improve the prediction performance of the physical property prediction model PPM by training using the design layout LayO generated by the layout generator 500. Additionally, as discussed above, the design layout LayO may be provided to semiconductor fabricating equipment 20.

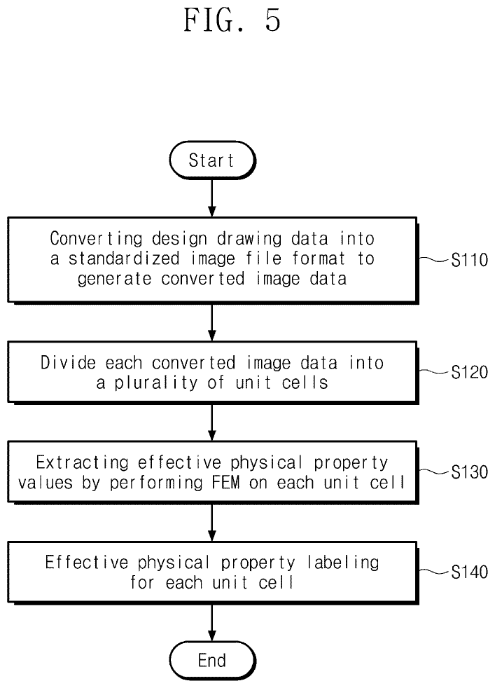

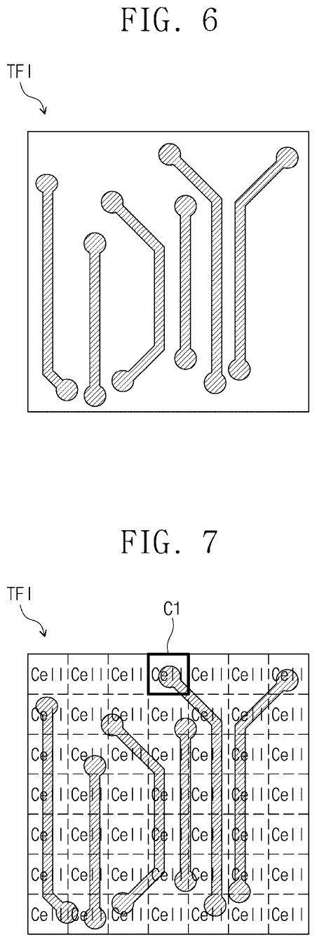

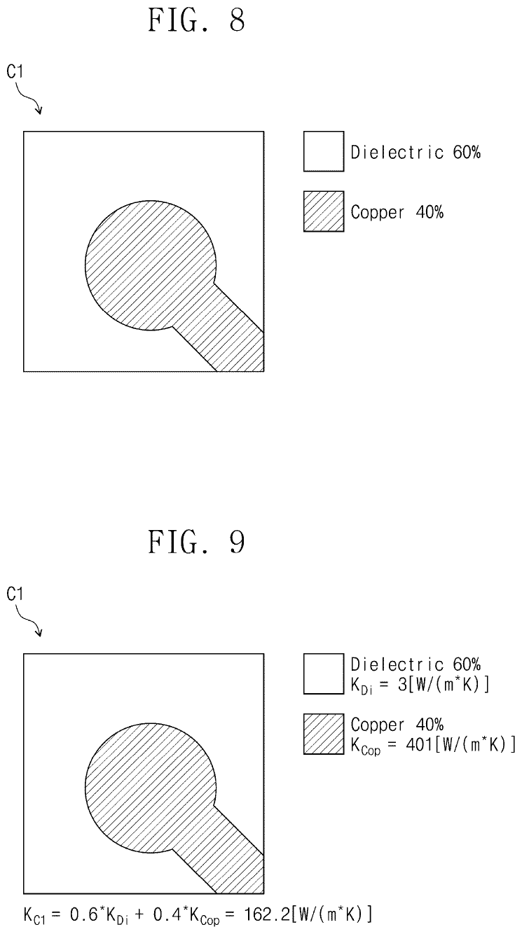

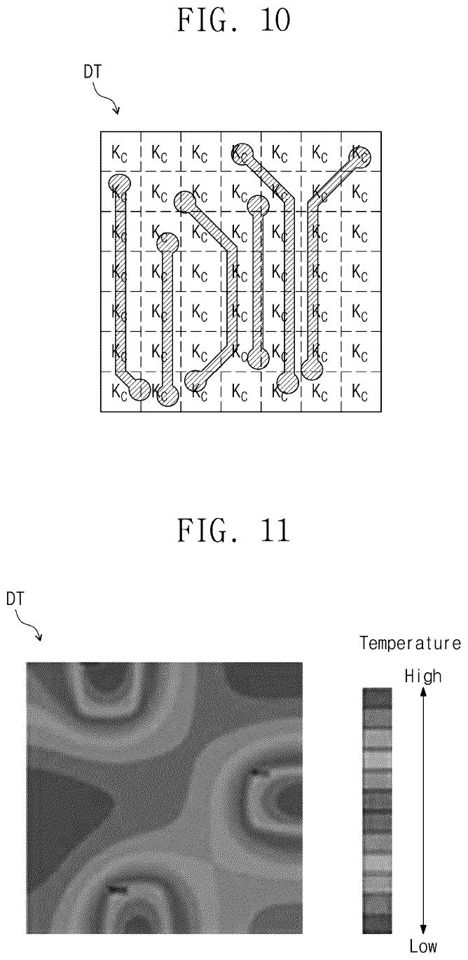

FIG. 4 is a block diagram illustrating specific configurations of a training data preprocessing unit of FIG. 2. FIG. 5 is a flowchart for describing an operation of a training data preprocessing unit of FIG. 4. FIG. 6 is a diagram illustrating an example of converted image data generated in a training data preprocessing unit of FIG. 4. FIG. 7 is a diagram illustrating an example of divided image data divided by an image divider of FIG. 4. FIG. 8 is an enlarged view of a first unit cell in divided image data of FIG. 7. FIGS. 9 and 10 are diagrams for describing that a FEM processing unit of FIG. 4 extracts effective physical property values. FIG. 11 is a diagram for describing that a physical property labeling unit of FIG. 4 labels effective physical property values.

Hereinafter, an operation of the training data preprocessing unit 200 will be described in detail with reference to FIGS. 4 to 11.

Referring to FIG. 4, the training data preprocessing unit 200 may include an image converter 210, an image divider 220, a FEM processing unit 230, and a physical property labeling unit 240.

The image converter 210 may receive the design drawing data DDi from the data base 100.

Referring to FIGS. 5 and 6 together with FIG. 4, in operation S110, the image converter 210 may convert the received design drawing data DDi into a standardized image file format to generate converted image data TFI. For example, the image converter 210 may convert the design drawing data DDi of the design data DD into a JPG, PNG, PEG, TIF, GIF, or PNG format file of a specific size to generate the converted image data TFI.

In some embodiments, the image converter 210 may receive experimental data among the design drawing data DDi, may standardize it to a uniform size, and may convert it into the JPG file format. In some embodiments, the image converter 210 may receive the CAD data among the design drawing data DDi and may convert it into image data in the JPG file format. The converted image data TFI generated by the image converter 210 may be provided to the image divider 220.

In the case of the design drawing data DDi having the same size and the same file format as the converted image data TFI, unlike the illustrated drawing, the design drawing data DDi may be directly provided to the image divider 220 without being converted in the image converter 210. For example, a separate conversion operation may not be performed with respect to analysis data in a JPG file format that is already standardized among the design drawing data DDi.

In operation S120, the image divider 220 may be configured to divide the converted image data TFI received from the image converter 210 into a plurality of unit cells. Each unit cell may include a pattern composed of metal and/or nonmetal.

The image divider 220 may be configured to generate divided image data CDI by dividing the converted image data TFI into N×N unit cells. The image divider 220 may provide the divided image data CDI divided into the unit cells to the FEM processing unit 230. For example, as illustrated in FIG. 7, the image divider 220 may divide the converted image data TFI into 7×7 unit cells.

In operation S130, the FEM processing unit 230 may be configured to extract an effective physical property value EPV on each unit cell of the divided image data CDI through the finite element method FEM.

The FEM processing unit 230 may receive the design property data DDp. The design property data DDp may include information associated with thermal and electrical properties of a metal material and a nonmetal material. For example, the metal material may be copper, and the nonmetal material may be an insulating material including silicon. For example, the design property data DDp may include thermal conductivity of copper and thermal conductivity of the insulating material.

The FEM processing unit 230 may extract the effective physical property value EPV of the unit cells based on the metal and nonmetal patterns arranged in the unit cells.

In some embodiments, the FEM processing unit 230 may calculate a ratio of metal and nonmetal in each unit cell. The FEM processing unit 230 may extract the effective physical property value EPV of the unit cell using the design property data DDp based on the calculated ratio. Hereinafter, extraction of the effective physical property value EPV for each unit cell will be representatively described with reference to FIGS. 8 and 9.

Referring to FIG. 8, the FEM processing unit 230 may extract the effective physical property value EPV for a first unit cell C1 among the unit cells. The FEM processing unit 230 may extract a ratio of metal and nonmetal in the first unit cell C1. For example, 40% of the first unit cell C1 may be copper, which is a metal, and 60% of the first unit cell C1 may be an insulating material.

Referring to FIG. 9, the FEM processing unit 230 may extract the effective physical property value EPV of the first unit cell C1 based on physical property data of copper and the insulating material among the design physical property data DDp. For example, the physical property data may be thermal conductivity. The thermal conductivity of copper may be 401 W/(m*K), and the thermal conductivity of the insulating material may be 3 W/(m*K).

In some embodiments, the FEM processing unit 230 may calculate the effective thermal conductivity (effective physical property value EPV) of the first unit cell C1 as KC1=0.6*KDi+0.4*KCop=162.2 [W/(m*K)] based on the ratio of copper to insulating material and the physical property data of copper and insulating material. In other words, the effective thermal conductivity (effective physical property value EPV) may be calculated as a weighted average of the thermal conductivity of the metal material and the thermal conductivity of the insulating material.

However, the present disclosure is not limited thereto, and the FEM processing unit 230 may calculate the effective physical property value EPV with respect to the unit cells in a different way.

Referring back to FIGS. 4 and 5, in operation S140, the physical property labeling unit 240 may receive the divided image data CDI divided into unit cells and the effective physical property value EPV with regard to the unit cells. The physical property labeling unit 240 may be configured to generate the training data DT by labeling each unit cell with the effective physical property value EPV.

For example, referring to FIG. 10, the physical property labeling unit 240 may label each unit cell with the effective thermal conductivity.

For example, referring to FIG. 11, the physical property labeling unit 240 may set and label predicted temperature values during operation of the semiconductor device in each unit cell. A unit cell with a high effective thermal conductivity may be labeled with a relatively high temperature, and a unit cell with a low effective thermal conductivity may be labeled with a relatively low temperature.

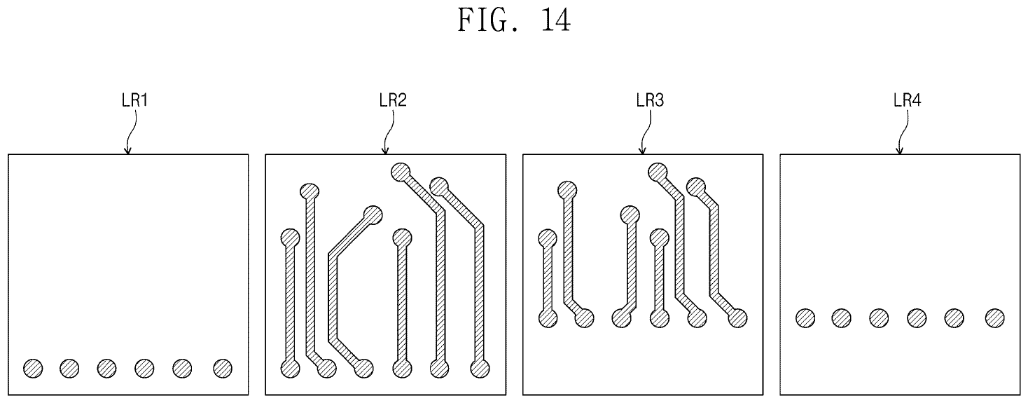

FIG. 12 is a flowchart for describing an operation of generating predicted physical property data by a physical property prediction unit of FIG. 2. FIG. 13 is a diagram illustrating an example of a semiconductor device to be designed in a semiconductor fabricating system of FIG. 2. FIG. 14 is a diagram illustrating design drawings of layers constituting a semiconductor device of FIG. 13. Hereinafter, an operation of the physical property prediction unit 400 will be described in detail with reference to FIGS. 12 to 14.

Referring to FIG. 12, in operation S210, the physical property prediction unit 400 may receive the input data DI. The input data DI may include information associated with the design drawings for fabricating a semiconductor device.

Referring to FIGS. 13 and 14, in some embodiments, the input data DI may include the design drawings for fabricating a package substrate PSUB. For example, the package substrate PSUB may include first to fourth layers LR1, LR2, LR3, and LR4. The input data DI may include a design drawing for the first layer LR1, a design drawing for the second layer LR2, a design drawing for the third layer LR3, and a design drawing for the fourth layer LR4.

In operation S220, the physical property prediction unit 400 may generate sub-predicted physical property data for each of the design drawings included in the input data DI by using the property prediction model PPM. The sub-predicted property data may include information associated with the predicted property values predicted in each of the design drawings for the first to fourth layers LR1, LR2, LR3, and LR4.

In operation S230, the physical property prediction unit 400 may generate the predicted physical property data PD of the semiconductor device based on the sub-predicted physical property data of the design drawings. For example, the physical property prediction unit 400 may generate the predicted physical property data PD by summing the sub-predicted physical property data of each region of unit cells in the semiconductor device.

In some embodiments according to the present disclosure, since physical properties of a semiconductor device may be predicted using the design drawings in the form of image data having an image file format without using the CAD data, security and/or accuracy may be improved in predicting physical properties.

According to some embodiments of the present disclosure, drawings in a low-capacity image file format can be used to predict physical properties of a semiconductor device, so storage capacity may be reduced, calculation speed may be improved, and power consumption during prediction may be reduced.

An embodiment according to the present disclosure may predict physical properties of a semiconductor device and may generate the optimized design layout LayO based on the predicted physical properties.

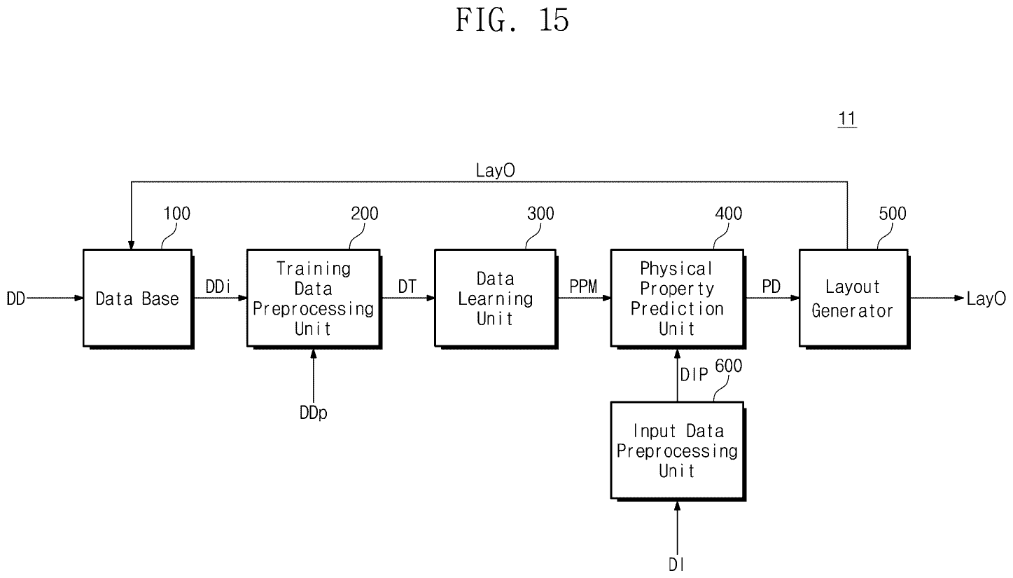

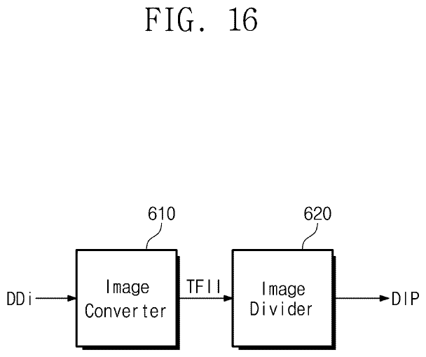

FIG. 15 is a block diagram illustrating an embodiment of a semiconductor design optimization system as seen in FIG. 1, according to some aspects of the present disclosure. FIG. 16 is a block diagram illustrating an input data preprocessing unit of FIG. 15. Hereinafter, some embodiments will be described focusing mainly on differences from embodiments of the semiconductor design optimization system described with reference to FIGS. 2 to 14.

Referring to FIG. 15, some embodiments of a semiconductor design optimization system according to the present disclosure may include a data base 100, a training data preprocessing unit 200, a data learning unit 300, a physical property prediction unit 400, a layout generator. 500, and an input data preprocessing unit 600.

The data base 100, the training data preprocessing unit 200, the data learning unit 300, the property prediction unit 400, and the layout generator 500 may be the same as or substantially similar to those described above with reference to FIGS. 2 to 14. In other words, an embodiment according to FIG. 15 may be one in which the input data preprocessor 600 is added to an embodiment according to FIG. 2.

In some embodiments, the input data DI may include non-standardized design drawings of the semiconductor device. For example, the input data DI may be provided in the form of a CAD drawing file or a simulation layout file.

The input data preprocessing unit 600 may be configured to preprocess the input data DI and generate preprocessed input data TFII.

Referring to FIG. 16, the input data preprocessing unit 600 may include an image converter 610 and an image divider 620.

The image converter 610 may generate converted input data DI by converting design drawings of the input data DI into a standardized image file format. A detailed operation of the image converter 610 may be actually the same as that of the image converter 210 described with reference to FIG. 4.

The image divider 620 may receive the converted input data DI. The image divider 620 may generate divided input data DIP by dividing the design drawings of the received converted input data DI into a plurality of unit cells. A detailed operation of the image divider 620 may be actually the same as that of the image divider 220 described with reference to FIG. 4.

The physical property prediction unit 400 may receive the divided input data DIP from the image divider 620. The property prediction unit 400 may be configured to generate the predicted property data PD with regard to the semiconductor device based on the divided input data DIP by using the property prediction model PPM. A detailed operation of the physical property prediction unit 400 may be actually the same as that of the physical property prediction unit 400 described with reference to FIGS. 12 to 14.

According to some embodiments of the present disclosure, systems for predicting physical properties of semiconductor devices using image data of design drawings are provided.

According to some embodiment of the present disclosure, systems for predicting physical properties of semiconductor devices and for generating design layouts with optimized physical properties are provided.

The above descriptions are examples of embodiments for carrying out the present disclosure. Embodiments in which a design is changed simply or which are easily changed are included in the present disclosure as well as the embodiments described above. In addition, technologies that are easily changed and implemented by using the above embodiments are included in the present disclosure. Therefore, the scope of the present disclosure should not be limited to the above-described embodiments, but should be defined by the claims provided below and equivalents thereof.

1. A semiconductor design optimization system comprising:
a data base configured to store design data;
a training data preprocessing unit configured to obtain the design data from the data base and preprocess the design data, resulting in training data;
a data learning unit configured to generate a physical property prediction model by training using the training data;
a physical property prediction unit configured to generate predicted physical property data including information associated with predicted physical property values for each region of a semiconductor device to be fabricated, wherein the physical property prediction unit is configured to input, into the physical property prediction model, input data including information associated with design drawings of the semiconductor device to be fabricated; and
a layout generator configured to generate a design layout for the semiconductor device to be fabricated, wherein the design layout is optimized to distribute the predicted physical property values for each region of the semiconductor device by modifying the design drawings based on the predicted physical property data.

2. The semiconductor design optimization system of claim 1, wherein the design data includes design drawing data that includes design drawings of various semiconductor devices and design physical property data that includes physical property information associated with materials arranged in the design drawing data,
wherein the design drawing data includes the design drawings in a form of image data, and
wherein the design physical property data includes a thermal conductivity of a metal material and a thermal conductivity of an insulating material.

3. The semiconductor design optimization system of claim 2, wherein the training data preprocessing unit includes:
an image converter configured to generate converted image data by converting the design drawing data into a standardized image file format;
an image divider configured to generate divided image data by dividing the converted image data into a plurality of unit cells;
a FEM processing unit configured to extract an effective physical property value through a finite element method for each of the plurality of unit cells of the divided image data based on the design property data; and
a physical property labeling unit configured to generate the training data by labeling each of the plurality of unit cells of the divided image data with the effective property value extracted therefor.

4. The semiconductor design optimization system of claim 3, wherein the FEM processing unit is configured to extract an effective thermal conductivity through a thermal conductivity of a metal and a thermal conductivity of a nonmetal based on metal and nonmetal patterns arranged in each of the unit cells.

5. The semiconductor design optimization system of claim 1, wherein the data base is configured to store the design layout, and
wherein the physical property prediction model is configured to train using the design layout.

6. The semiconductor design optimization system of claim 1, wherein the input data includes information associated with patterns of wires or circuits arranged on the design drawings of the semiconductor device to be fabricated.

7. The semiconductor design optimization system of claim 6, wherein the physical property prediction unit is configured to generate sub-predicted property data for each of the design drawings.

8. The semiconductor design optimization system of claim 7, wherein the physical property prediction unit is configured to generate the predicted physical property data of the semiconductor device based on the sub-predicted property data of the design drawings.

9. The semiconductor design optimization system of claim 8, wherein the semiconductor device includes a PCB substrate, a semiconductor substrate, a package substrate, a semiconductor chip, or a semiconductor package.

10. The semiconductor design optimization system of claim 1, further comprising:
an input data preprocessing unit configured to generate preprocessed input data by preprocessing the input data, and
wherein the physical property prediction unit is configured to generate the predicted physical property data of the input data by inputting the preprocessed input data into the physical property prediction model.

11. A semiconductor optimization method, comprising:
generating training data by preprocessing design data;
generating a physical property prediction model by training using the training data;
generating predicted physical property data including information associated with predicted physical property values for each region of a semiconductor device to be fabricated, including inputting, into the physical property prediction model, input data including information associated with design drawings of the semiconductor device to be fabricated; and
generating a design layout optimized to distribute the predicted physical property values for each region of the semiconductor device by modifying the design drawings based on the predicted physical property data.

12. The semiconductor optimization method of claim 11, wherein the design data includes design drawing data that includes design drawings of the semiconductor device and design physical property data that includes physical property information associated with materials arranged in the design drawing data,
wherein the design drawing data includes the design drawings in a form of image data, and
wherein the design physical property data includes a thermal conductivity of a metal material and a thermal conductivity of an insulating material.

13. The semiconductor optimization method of claim 11, wherein the generating of the training data further includes:
generating converted image data by converting the design drawing data into a standardized image file format;
generating divided image data by dividing the converted image data into a plurality of unit cells;
extracting an effective physical property value through a finite element method for each of the plurality of unit cells of the divided image data based on the design physical property data; and
labeling each of the plurality of unit cells of the divided image data with the effective property value.

14. The semiconductor optimization method of claim 13, wherein the extracting of the effective physical property value includes extracting an effective thermal conductivity through a thermal conductivity of a metal and a thermal conductivity of a nonmetal based on metal and nonmetal patterns arranged in each of the unit cells.

15. The semiconductor optimization method of claim 11, wherein the generating of the physical property prediction model includes training the design layout.

16. The semiconductor optimization method of claim 11, wherein the input data includes information associated with patterns of wires, circuits, etc. arranged on the design drawings of the semiconductor device to be fabricated, and wherein the method further comprises fabricating the semiconductor device.

17. The semiconductor optimization method of claim 11, wherein the generating of the predicted physical property data includes:
generating sub-predicted physical property data for each of the design drawings; and
generating the predicted physical property data of the semiconductor device based on the sub-predicted physical property data of the design drawings.

18. A semiconductor design optimization system comprising:
a training data preprocessing unit configured to generate training data including a plurality of unit cells each labeled with an effective physical property value, wherein the training data preprocessing unit is configured to preprocess design drawings of a semiconductor device to be fabricated and physical property information associated with materials arranged in the design drawings;
a data learning unit configured to generate a physical property prediction model as a result of a training using the training data; and
a physical property prediction unit configured to generate predicted physical property values for each region of the semiconductor device to be fabricated, wherein the physical property prediction unit is configured to input, into the physical property prediction model, information that is associated with the design drawings of the semiconductor device to be fabricated, and
wherein the design drawings are in a form of image data, and
wherein the physical property information includes a thermal conductivity of a metal material and a thermal conductivity of an insulating material.

19. The semiconductor design optimization system of claim 18, wherein the training data preprocessing unit includes:
an image converter configured to generate converted image data by converting the design drawings into a standardized image file format;
an image divider configured to generate divided image data by dividing the converted image data into a plurality of unit cells;
a FEM processing unit configured to extract an effective physical property value through a finite element method for each of the plurality of unit cells of the divided image data based on the physical property information; and
a physical property labeling unit configured to generate the training data by labeling each of the plurality of unit cells of the divided image data with the effective property value.

20. The semiconductor design optimization system of claim 19, wherein the FEM processing unit is configured to extract an effective thermal conductivity through a thermal conductivity of a metal and a thermal conductivity of a nonmetal based on metal and nonmetal patterns arranged in each of the unit cells.

21. (canceled)
